(19) United States
(12) Patent Application Publication
(10) Pub. No.: US 2017/0351834 A1
(43) Pub. Date: Dec. 7, 2017

(54) PERSONAL TRAVEL HEALTH VULNERABILITY NAVIGATOR

(71) Applicant: International Business Machines Corporation, Armonk, NY (US)

(72) Inventors: Amos CAHAN, Dobbs Ferry, NY (US); Hung-yang CHANG, Scarsdale, NY (US); Ning LI, White Plains, NY (US); Fei LIU, Yorktown Heights, NY (US); Qiqing Christine OUYANG, Yorktown Heights, NY (US); Yajuan WANG, White Plains, NY (US)

(21) Appl. No.: 15/171,595

(22) Filed: Jun. 2, 2016

Related U.S. Application Data
(63) Continuation of application No. 15/170,052, filed on Jun. 1, 2016.

(51) Int. Cl. G06F 19/00; G06Q 50/14

(52) U.S. Cl. CPC G06F 19/3431; G06Q 50/14

(57) ABSTRACT

Individual health vulnerability is assessed by obtaining health risk prevalence level data containing health risk prevalence levels for one or more health risks over a given geographical area. The health risk prevalence level data to generate for each health risk a prevalence level forecast as a function of time and location. A health risk prevalence level map is generated for the given geographical area illustrating current and future health risk prevalence levels for each health risk at a plurality of locations within the given geographical area. Personal health status data are obtained for a given individual along with a proposed travel itinerary f covering at least a portion of the geographical area over a given time duration. The personal health status data, travel itinerary and map generate a personal health risk vulnerability model containing a quantification of vulnerability to the one or more health risks resulting from the travel itinerary.

### FIELD OF THE INVENTION

The present invention relates to systems and methods for controlling personal health.

### BACKGROUND OF THE INVENTION

Traveling presents potential health risks to travelers. These health risks include risks of contacting infectious diseases and risks of aggravating—pre-existing conditions in travelers due to environmental, climatic or geographical conditions along a given travel route. Therefore, the desired travel itinerary including the length of travel, the travel route and the timing of that travel affects exposure to health risks. Additional factors affecting health risks relate to the general health of the traveler. For example, travelers with chronic conditions or special needs are adversely affected by certain travel conditions or may require certain accommodations during travel. Even relatively healthy or condition free travelers would want to be informed of potential health risk exposures during travel such as threats of infectious diseases or poor sanitary conditions.

Conventional health risk travel information covers large geographic areas and represents data gathered at a population level. The data typically cover only infectious diseases and known outbreaks of infectious diseases. This information is not always up to date or updated regularly. In addition, the specificity of this information does not extend to the level of specific locations on a travel itinerary. Moreover, the health risk travel information is not customized to a given individual and does not take into account health risk factors unique to that individual.

### SUMMARY OF THE INVENTION

Exemplary embodiments are directed to systems and methods for assessing personal or individual vulnerability to a variety of health risks resulting from a proposed travel itinerary. Therefore, the travel itinerary can be improved to optimize or to minimize the health vulnerability of that individual resulting from the proposed travel. An active health risk prevalence level map is created that dynamically captures and provides health risk prevalence level information with fine granularity on both geographic and time dimensions. A personal health vulnerability navigator provides information for personal health risk prevention, health risk management and optimized travel itinerary planning to minimize individual health risk vulnerability.

In one embodiment, the health risk prevalence level map is produced by integrating intelligence information from official and crowd sourced disease prevalence data dynamically. The health risk prevalence level map also utilizes a forecasting module to project the health risk prevalence level information at a specific location with a specific time. In one embodiment, the individual health risk vulnerability system utilizes a plurality of modules including, for example, a patient health risk module that learns health risk models from retrospective data and that updates the model based on new data feeds, a health risk prevalence travel journey module that extracts and forecasts relevant health risk prevalence information around an individual travel itinerary on both geographic and time dimensions, an individual travel health vulnerability module that learns the vulnerability based on both a risk and a prevalence trajectory and an individual travel route optimizer module that optimizes a travel route or proposed travel itinerary to minimize health vulnerability risk under travel schedule constraints.

In one embodiment of a live or current health risk prevalence map, the inputs are official data that provide accurate public health risk or disease prevalence information at relatively large geo-locations and time scales in combination with crowd sourced data, for example, using mobile computing device applications or social media sites, that adds the fine details and dynamic information, improving map space resolution and time sensitivity. This allows an individual or user to update the system when having symptoms and associate those with the location where the user is and the travel history directly, for example, through an application on a smart phone. Distributed individual or crowd based data collection facilitates early detection of outbreaks. Relevant health risk prevalence information is aggregated from multiple sources and the resulting map or maps (e.g., live disease prevalence map, weather map, pollution factory map and geographic altitude map) of health risk prevalence data is updated dynamically. In addition, historical health risk data are leveraged to predict the future status of health risk prevalence at specific locations and specific times. The result is a live health risk prevalence map and a projected disease prevalence map covering future time periods that can be output and displayed to an individual.

A personal or individual vulnerability navigator takes as inputs personal demographic and available clinical information. This information is used to assess personal health risks. In addition, an individual travel schedule and information are input and used to retrieve relevant disease prevalence information from the live health risk prevalence map and any other maps. A travel based personal health risk prevalence model is projected and predicted based on the travel itinerary and active prevalence map. Individual health risk models are normal health risk models developed using retrospective data. An individual vulnerability model uses models that have been developed to assess personal health risks. These models can be augmented with the impact of health risk prevalence in the proposed travel itinerary as well as other environmental factors. A traveling route optimizer is used to optimize the personal vulnerability risk with the constraints of traveling schedule and time. A health risk prevention and risk control advisor provides tips to the traveler to manage health risks. The resulting outputs are disease prevalence and risk control advice for an individual traveler, a personal travel health vulnerability score and a dynamically optimized travel route for each individual with the consideration of minimized travel health vulnerability and constrained travel plan.

One exemplary embodiment is directed to a method for assessing individual health vulnerability that obtains health risk prevalence level data containing temporally and spatially varying health risk prevalence levels for one or more health risks over a given geographical area. In one embodiment, at least one of aggregate health risk prevalence data covering a plurality of individuals within the given geographical area and individual health risk prevalence data covering individuals at specific locations within the given geographical area are obtained. Suitable health risk prevalence level data include, but are not limited to, a prevalence of infectious disease, a prevalence of climate factors affecting health conditions, a prevalence of geographical features affecting health conditions, a prevalence of sanitation factors affecting health conditions, a prevalence of medical infrastructure, prevalence of environmental factors affecting health conditions and combinations thereof. In one embodiment, the obtained health risk prevalence data are aggregated to generate the current health risk prevalence levels for each health risk at the plurality of locations within the given geographical area.

The method uses the health risk prevalence level data to generate for each health risk a prevalence level forecast as a function of time and location. each prevalence level forecast, each current health risk prevalence level and each future health risk prevalence level can be updated dynamically in real time as additional health risk prevalence level data are obtained. The health risk prevalence level data and prevalence level forecasts are used to generate a health risk prevalence level map for the given geographical area illustrating current and future health risk prevalence levels for each health risk at a plurality of locations within the given geographical area. In one embodiment, the health risk prevalence level data and prevalence level forecasts are used to generate a plurality of health risk prevalence level maps for the given geographical area. Each health risk prevalence map illustrates current and future health risk prevalence levels for a single health risk at a plurality of locations within the given geographical area.

The method also obtains personal health status data for a given individual and identifies a proposed travel itinerary for the given individual. The proposed travel itinerary covers at least a portion of the geographical area over a given time duration. The personal health status data, the proposed travel itinerary and the health risk prevalence level map are used to generate a personal health risk vulnerability model for the given individual that expresses a quantification of vulnerability to the one or more health risks resulting from the proposed travel itinerary. In one embodiment, an individual health risk probability for succumbing to each health risk is determined for the given individual and all health risks. In addition, a projected health risk prevalence level over time at each one of the plurality of locations within the geographical area is determined for each health risk. the individual health risk probability for succumbing and the projected health risk prevalence level for all health risks, all locations contained in the portion of the geographical of the proposed travel itinerary and the given time duration of the proposed travel itinerary are used to generate the personal health risk vulnerability model.

In one embodiment, the method includes using the vulnerability model to determine a proposed travel itinerary overall vulnerability level value and providing to the given individual an alternative travel itinerary having a modified overall vulnerability level value that is less than the proposed travel itinerary overall vulnerability level value. In one embodiment, the alternative travel itinerary is selected to maximize a similarity between the alternative travel itinerary and the proposed travel itinerary, reduce the overall vulnerability level value, minimize travel time and minimize travel costs. In one embodiment, the vulnerability model is used to determine a proposed travel itinerary overall vulnerability level value, and the proposed travel itinerary is displayed in a graphical user interface. The graphical user interface is used to manipulate the proposed travel itinerary into an alternative travel itinerary, and a modified overall vulnerability level value associated with the alternative travel itinerary is determined. The modified overall vulnerability level value is also displayed in the graphical user interface. In one embodiment, the personal health status data for the given individual is updated, and the personal health status data, the proposed travel itinerary and the updated health risk prevalence level map are used to generate an updated personal health risk vulnerability model for the given individual.

An exemplary embodiment is directed to a method for assessing individual health vulnerability that obtains a health risk prevalence level map for a given geographical area illustrating current and future health risk prevalence levels for one or more health risks at a plurality of locations within the given geographical area. In addition, personal health status data are obtained for a given individual, and a proposed travel itinerary is identified for the given individual. The proposed travel itinerary covers at least a portion of the geographical area over a given time duration. The personal health status data, the proposed travel itinerary and the health risk prevalence level map are used to generate a personal health risk vulnerability model for the given individual comprising a quantification of vulnerability to the one or more health risks resulting from the proposed travel itinerary. In one embodiment, using the personal health status data, the proposed travel itinerary and the health risk prevalence level map to generate the personal health risk vulnerability model further includes determining for the given individual and all health risks an individual health risk probability for succumbing to each health risk. In one embodiment, using the personal health status data, the proposed travel itinerary and the health risk prevalence level map to generate the personal health risk vulnerability model further includes determining for each health risk a projected health risk prevalence level over time at each one of the plurality of locations within the geographical area. In one embodiment, using the personal health status data, the proposed travel itinerary and the health risk prevalence level map to generate the personal health risk vulnerability model further includes using the individual health risk probability for succumbing and the projected health risk prevalence level for all health risks, all locations contained in the portion of the geographical of the proposed travel itinerary and the given time duration of the proposed travel itinerary to generate the personal health risk vulnerability model.

In one embodiment, the method includes using the personal health risk vulnerability model to determine a proposed travel itinerary overall vulnerability level value and providing to the given individual an alternative travel itinerary having a modified overall vulnerability level value that is less than the proposed travel itinerary overall vulnerability level value. In one embodiment, providing the alternative travel itinerary includes selecting the alternative travel itinerary to maximize a similarity between the alternative travel itinerary and the proposed travel itinerary, reduce the overall vulnerability level value, minimize travel time and minimize travel costs. In one embodiment, the method includes using the personal health risk vulnerability model to determine a proposed travel itinerary overall vulnerability level value, displaying the proposed travel itinerary in a graphical user interface, using the graphical user interface to manipulate the proposed travel itinerary into an alternative travel itinerary, determining a modified overall vulnerability level value associated with the alternative travel itinerary and displaying the modified overall vulnerability level value in the graphical user interface.

In one embodiment, the method includes updating the personal health status data for the given individual, updating the health risk prevalence level map and using the updated personal health status data, the proposed travel itinerary and the updated health risk prevalence level map to generate an updated personal health risk vulnerability model for the given individual. In one embodiment, health risk prevalence level data and prevalence level forecasts are used to generate the health risk prevalence level map for the given geographical area illustrating current and future health risk prevalence levels for each health risk at the plurality of locations within the given geographical area.

An exemplary embodiment is directed to an individual health vulnerability navigator having a health risk prevalence module to obtain health risk prevalence level data comprising temporally and spatially varying health risk prevalence levels for one or more health risks over a given geographical area, a health risk prevalence forecasting module to use the health risk prevalence level data to generate for each health risk a prevalence level forecast as a function of time and location and a health risk prevalence mapping module to use the health risk prevalence level data and prevalence level forecasts to generate a health risk prevalence level map for the given geographical area illustrating current and future health risk prevalence levels for each health risk at a plurality of locations within the given geographical area. In one embodiment, at least one computing system is included, and the health risk prevalence module, the health risk forecasting module and the health risk prevalence mapping module are executing on the computing system. Suitable health risk prevalence level data include, but are not limited to, a prevalence of infectious disease, a prevalence of climate factors affecting health conditions, a prevalence of geographical features affecting health conditions, a prevalence of sanitation factors affecting health conditions, a prevalence of medical infrastructure, prevalence of environmental factors affecting health conditions and combinations thereof.

In one embodiment, the health risk prevalence module is in communication with at least one aggregate health risk prevalence data source supplying aggregate health risk prevalence data covering a plurality of individuals within the given geographical area and a plurality of distributed individual health risk prevalence data sources supplying individual health risk prevalence data covering individuals at specific locations within the given geographical area. In one embodiment, the individual health vulnerability navigator includes a health risk prevalence level data aggregating module in communication with the health risk prevalence forecasting module to aggregate all obtained health risk prevalence level data. The health risk prevalence forecasting module includes a forecast engine to use all obtained health risk prevalence level data to generate a plurality of prevalence level forecasts, one for each health risk. In one embodiment, the individual health vulnerability navigator includes a graphical user interface. The health risk prevalence level map is displayed in the graphical user interface. In one embodiment, the health risk prevalence level map includes a plurality of health risk prevalence level maps displayed in a layered arrangement in the graphical user interface. Each individual prevalence level map is associated with one health risk. In one embodiment, the health risk prevalence level map is an interactive graphical display.

In one embodiment, the individual health vulnerability navigator includes an individual health risk input module to obtain personal health status data for a given individual and a proposed travel itinerary for the given individual. The proposed travel itinerary covers at least a portion of the geographical area over a given time duration. The personal health status data include a progression model forecast comprising projected future changes in health status of the given individual. In one embodiment, the individual health vulnerability navigator includes an individual health risk probability module to use personal health status data to generate for the given individual and all health risks an individual health risk probability for succumbing to each health risk. In one embodiment, the individual health vulnerability navigator includes a projected disease prevalence module to use the health risk prevalence level map and a proposed travel itinerary to determine for each health risk a projected health risk prevalence level over time at each one of the plurality of locations within the geographical area. In one embodiment, the projected health risk prevalence level is a function of a time-varying and space-varying prevalence level function for each health risk and a constant factor comprising a standard prevalence level for each health risk.

In one embodiment, the individual health vulnerability navigator includes an individual travel health vulnerability module to use an individual health risk probability for succumbing to each health risk and a projected health risk prevalence level for all health risks, all locations contained in a proposed travel itinerary and a given time duration of the proposed travel itinerary to generate a personal health risk vulnerability model.

Exemplary embodiments are directed to an individual health vulnerability navigator containing an individual health risk input module to obtain personal health status data for a given individual and a proposed travel itinerary for the given individual. The proposed travel itinerary covers at least a portion of a geographical area over a given time duration. Also included are an individual health risk probability module to use the personal health status data to generate for the given individual and all health risks an individual health risk probability for succumbing to each health risk, a projected disease prevalence module to use a health risk prevalence level map and the proposed travel itinerary to determine for each health risk a projected health risk prevalence level over time at each one of the plurality of locations within the geographical area and an individual travel health vulnerability module to use the individual health risk probability for succumbing and the projected health risk prevalence level for all health risks, all locations contained in the portion of the geographical of the proposed travel itinerary and the given time duration of the proposed travel itinerary to generate the personal health risk vulnerability model.

In one embodiment, the personal health status data is a progression model forecast containing projected future changes in health status of the given individual. In one embodiment, the projected health risk prevalence level is a function of a time-varying and space-varying prevalence level function for each health risk and a constant factor containing a standard prevalence level for each health risk. In one embodiment, the individual health vulnerability navigator includes at least one computing system, and the individual health risk input module, the individual health risk probability module, the projected disease prevalence module and the individual travel health vulnerability module are executing on the computing system. In one embodiment, the individual health vulnerability navigator includes a health risk prevalence module to obtain health risk prevalence level data comprising temporally and spatially varying health risk prevalence levels for one or more health risks over the given geographical area. In one embodiment, the health risk prevalence level data include a prevalence of infectious disease, a prevalence of climate factors affecting health conditions, a prevalence of geographical features affecting health conditions, a prevalence of sanitation factors affecting health conditions, a prevalence of medical infrastructure, prevalence of environmental factors affecting health conditions or combinations thereof.

In one embodiment, the health risk prevalence module is in communication with at least one aggregate health risk prevalence data source supplying aggregate health risk prevalence data covering a plurality of individuals within the given geographical area and a plurality of distributed individual health risk prevalence data sources supplying individual health risk prevalence data covering individuals at specific locations within the given geographical area. In one embodiment, the individual health vulnerability navigator includes a health risk forecasting module to use the health risk prevalence level data to generate for each health risk a prevalence level forecast as a function of time and location. In one embodiment, the health risk prevalence forecasting module includes a forecast engine to use all obtained health risk prevalence level data to generate a plurality of prevalence level forecasts, one for each health risk. In one embodiment, the individual health vulnerability navigator includes a health risk prevalence level data aggregating module in communication with the health risk prevalence forecasting module to aggregate all obtained health risk prevalence level data.

In one embodiment, the individual health vulnerability navigator includes a graphical user interface. A health risk prevalence level map illustrating the proposed travel itinerary is displayed in the graphical user interface. In one embodiment, the health risk prevalence level map includes a plurality of health risk prevalence level maps displayed in a layered arrangement in the graphical user interface, each individual prevalence level map associated with one health risk. In one embodiment, the health risk prevalence level map is an interactive graphical display. In one embodiment, the health risk prevalence level map illustrates an alternative travel itinerary separate from the proposed travel itinerary. The proposed travel itinerary has a proposed travel itinerary overall vulnerability level value, and the alternative travel itinerary has an alternative travel itinerary overall vulnerability level value. The alternative travel itinerary overall vulnerability level value is less than the proposed travel itinerary overall vulnerability level value. In one embodiment, the individual health vulnerability navigator includes a health risk prevention and control advisor module and a travel itinerary optimizer module to optimize spatial and temporal aspects of the proposed travel itinerary to minimize a proposed travel itinerary overall vulnerability level value. In one embodiment, the travel itinerary optimizer module includes a travel route optimizer module and a travel time optimizer module. In one embodiment, the individual health vulnerability navigator includes a health risk prevalence mapping module to use the health risk prevalence level data and prevalence level forecasts to generate a health risk prevalence level map for the given geographical area illustrating current and future health risk prevalence levels for each health risk at a plurality of locations within the given geographical area.

### BRIEF DESCRIPTION OF THE DRAWINGS

FIG. 1 is a schematic representation illustrating an embodiment of an individual health vulnerability navigator in accordance with the present invention;

FIG. 2 is a representation illustrating an embodiment of a health risk prevalence level map for displaying travel itineraries and health vulnerability levels; and

FIG. 3 is a flow chart illustrating an embodiment of a method for assessing individual health vulnerability.

### DETAILED DESCRIPTION

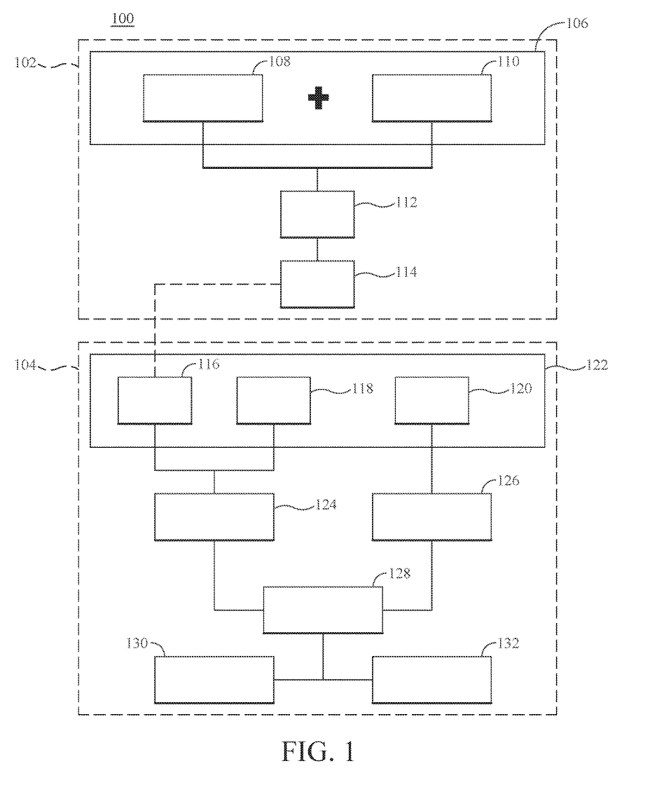

Referring initially to FIG. 1, exemplary embodiments are directed to an individual health vulnerability navigator 100. The individual health vulnerability navigator can be implemented on one or more computing systems and provides an individualized or personalized travel itinerary including a travel route that takes into account the specific health risk vulnerabilities of a particular individual and spatially and temporally varying health risk prevalence levels across a given geographical area. Therefore, recommendations for a travel itinerary covering the physical travel route through portions of the geographical area in combination with recommendations regarding the timing or duration of that travel itinerary can be made on an individual basis. These recommendations can be provided in the form of an interactive map or other graphical user interface and can be updated to provide the recommendations in real time as the health conditions of the user or the health risk prevalence levels across the geographical area change. The health risk prevalence level information leverages information obtained at both the population level and the individual level.

The individual health vulnerability navigator utilizes a plurality of modules executing on one or more computing systems. Any suitable computing system known and available in the art can be used including network based computing systems and distributed computing systems. Instances of the modules are running on one or more components within the computing system. These module instances are in communication across one or more local and wide area networks to obtain and share data. The modules can be grouped into general health risk modules 102 that obtain and maintain a map of health risk data across the geographical area and individual health vulnerability modules 104 that take individual health information into account to determine health risks for a given individual associated with a proposed travel itinerary.

The general health risk modules include a health risk prevalence module 106 that is an input module used to obtain health risk prevalence level data for a given geographical area and a plurality of locations within the geographical area. Suitable geographical areas include, but are not limited to, the entire globe, a region of the globe, a continent, one or more countries and one or more counties or cities within a given country. Suitable locations within the geographical area include, but are not limited to, any subdivision within the geographical area, e.g., a city, a neighborhood, a street, a mountain, a river and a region having a generally consistent geography. The health risk prevalence data include temporally and spatially varying health risk prevalence levels, i.e., levels that vary over time at a given location and vary from location to location, for one or more health risks over the given geographical area.

The health risk prevalence level data can be associated with or obtained from any health risks that affect the general health or physical state of individuals at various locations across the geographical area. Suitable health risk prevalence level data include, but are not limited to, a prevalence of infectious disease, a prevalence of climate factors affecting health conditions, a prevalence of geographical features affecting health conditions, a prevalence of sanitation factors affecting health conditions, a prevalence of medical infrastructure, prevalence of environmental factors affecting health conditions, e.g., radiation levels or industrial discharges, and combinations thereof. Therefore, the health risk prevalence module can take into account factors that affect both individuals in general as well as individuals with specific medical conditions. These factors cover infectious diseases and environmental conditions in addition to the infrastructure required to provide medical services and medical supplies while traveling. These factors will vary from location to location and can also vary over time due, for example, to changes in weather conditions, e.g., wind direction or precipitation, or seasonal variations, e.g., heat. Some factors may be ongoing health risk conditions such as poor sanitation, unsafe drinking water or a continuing water borne disease outbreak. These factors also cover epidemics such as a current infectious disease outbreak. Other factors may not vary over time but vary with location and can contribute to health risks, e.g., altitude, availability of medical services and lack of accommodations for persons with disabilities.

The obtained health risk prevalence level data include aggregate health risk prevalence data covering a plurality of individuals within the given geographical area 108 and individual health risk prevalence data covering individuals at specific locations within the given geographical area 110. The aggregate health risk prevalence data cover multiple individuals in a given area. For example, the aggregate health risk prevalence data can cover an entire population of a continent, country or city. These data are available from government or business sources, for example, official government offices or websites, e.g., the center for disease control, news sources, weather forecasting agencies, regulatory agencies, relief organizations and travel advisory websites, among others. In general, any source of aggregate data or data covering a given area regarding conditions affecting health risks to individuals can be used. These data can be obtained over time as the health risk prevalence levels change or the data are updated by their sources. The aggregate health risk prevalence data can also include historical data that provide an indication of historical norms, trends and cyclical events within the geographical area.

The individual health risk prevalence data represent data obtained over time from individuals located at specific locations within the geographical region or who traveled through a given location in the geographical location. These are point sources and provide a level of granularity in the health risk prevalence data of a specific location or a point location within the geographical area. The individual health risk prevalence data are obtained and updated continuously over time. Therefore, in addition to providing a high degree of granularity, the individual health risk prevalence data provide up-to-date, instantaneous data on health risk prevalence levels. These individual health risk prevalence data can be obtained using portable computing devices such as tablet computers and smartphones carried by individuals, for example, using an application running on those portable computing devices. The individual can report on current conditions at that location or on a current or recent health event experienced or witnessed by that individual. For example, the individual can report that there are no facilities for obtaining certain medications in a given area. Alternatively, the individual can report suffering from gastroenteritis. In addition, sensors embedded within the portable computing devices, on vehicles on which an individual is traveling or at a continuous data generating apparatus, e.g., a weather station, can be used to obtain individual health risk prevalence data within the geographical area.

All obtained health risk prevalence level data are then combined or further aggregated and communicated to a health risk prevalence forecasting module 112 using, for example, a health risk prevalence data aggregating module. The health risk forecasting module includes a forecast engine and uses all of the health risk prevalence level data to generate a prevalence level forecast as a function of time and location. This prevalence level forecast is generated for each health risk for which prevalence level data are obtained. Therefore, a plurality of prevalence level forecasts is generated, one for each health risk. These prevalence level forecasts can be updated regularly or continuously in real-time as additional or updated health risk prevalence data are obtained.

The general health risk modules also include a health risk prevalence mapping module 114. The health risk prevalence mapping modules uses the health risk prevalence level data in combination with the prevalence level forecasts communicated from the health risk forecasting module to generate a health risk prevalence level map. The health risk prevalence level map covers the given geographical area or at least a portion of the given geographical area. The health risk prevalence level map provides a visual illustration of at least one of current and future health risk prevalence levels for one or more of a plurality of health risks at a plurality of locations within the given geographical area. In one embodiment, a single health risk prevalence level map is provided covering the entire plurality of health risks in a single map or visual display. Alternatively, a plurality of health risk prevalence level maps is provided. Each individual health risk prevalence level map covers at least one health risk or two or more health risks. The plurality of health risk level maps can be provided in a layered arrangement in a graphical user interface such that each individual health risk prevalence level map can be selected and manipulated.

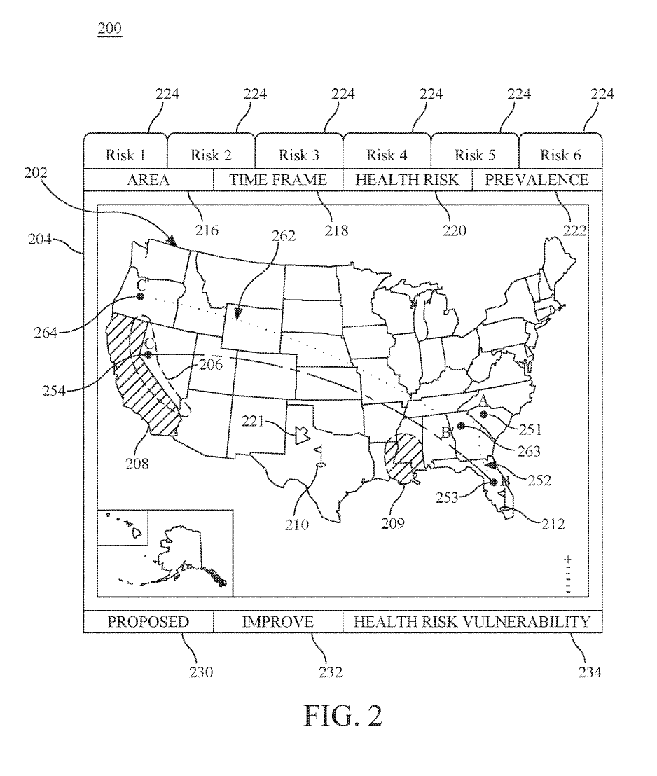

Referring to FIG. 2, an embodiment of a health risk prevalence level map 200 is illustrated. The health risk prevalence level map is an interactive graphical display containing an illustration of the geographical area 202 within an interactive window 204. The health risk prevalence level map 200 can be displayed on any suitable type of computing device including portable computing devices such as tablet computers and smart phones. Any suitable methods known and available in the art for manipulating graphical displays within a computer display environment can be used to manipulate the health risk prevalence level map. The illustrated geographical area that is displayed in the window provides indications of health risk prevalence levels associated with locations or regions within the geographical area at given time periods. These health risk prevalence levels can be obtained by selecting areas of the map using a point-and-click type device, using a touch screen or by moving a cursor 221 over a given location on the displayed geographical area. The window 204 provides an indication of the area 216 or location selected, the time frame, e.g., present or future, for which prevalence levels are currently displayed 218, the health risk or health risks associated with the prevalence level 220 and the prevalence level 222. In order to select or to display more specific areas of the geographical area, the interactive window includes a zoom function 214. The displayed geographical area can also include visual indications of prevalence levels that warrant consideration. These visual indications include flags for a specific region 210 under a heat advisory or a specific region 212 experiencing an infectious disease outbreak, a custom region 206 that is outlined to indicated a geographical feature such as high altitude, a custom region 209 that is colored, shaded or hatched to indicate a current condition affecting sanitary conditions such as flooding and a colored, shaded or hatched geopolitical region 208 indicating the need for a prescription in order to obtain certain medications.

While discussed as health risks that negatively affect individual health, the prevalence levels can also be associated with health risks that positively affect individual health, i.e., increased availability of services, accommodations for person with disabilities and high levels of sanitary infrastructure. In one embodiment, a single display of the geographical area covering all health risks is provided in the window. Alternatively, a plurality of separate stacked windows is provided, each with a separate, selectable tab 204. Each window, and therefore, each tab, is associated with a given health risk. Upon selecting that tab, the interactive geographical area illustration associated with that health risk is displayed.

Returning to FIG. 1, all of the generated health risk prevalence level maps are communication to an individual health risk input module 122 within the individual health vulnerability modules 104. In addition to the health risk prevalence level maps, the input module obtains the information and data necessary to provide an individualized health risk vulnerability level recommendation for travel itineraries and travel routes within and through the geographical area. An individualized recommendation requires information regarding how a given individual responds to exposure to any given health risk. Therefore, the individual health risk module also obtains personal health status data 120 for a given individual or for a plurality of individuals. Suitable personal health state data include, but are not limited to, individual demographical data and individual clinical or health data. As the health risk prevalence levels vary both temporally and spatially, the health risk module obtains a proposed travel itinerary 118 for each individual. The proposed travel itinerary covers at least a portion of the geographical area over a given time duration.

The individual health risk input module communicates the personal health status data for the given individual to an individual health risk probability module 126. The individual health risk probability module uses the personal health status data to generate for the given individual and all health risks an individual health risk probability for succumbing to each health risk. In one embodiment, the individual health risk probability module determines for a given individual, m, the probability of risk for health risk or health condition, j, which is indicated by pₘ(Dⱼ). The personal health status data, which can be updated over time, can be expressed as Xₘ, which is a set or matrix of scalar values related to a plurality of health status factors for the individual. The personal health status of an individual can vary overtime, for example, in accordance with a given prognosis for that health status. Certain conditions may be seasonal, i.e., allergies, may improve, i.e., recovery from surgery or a broken limb, may have a limited duration, e.g., pregnancy, or may deteriorate, e.g., a degenerative disease. Therefore, in one embodiment, the personal health status includes a progression model forecast to incorporate known or projected changes in health status for the individual. In addition, the health status factors can be assigned weights for each health status factor. These weights can be expressed as a vector β and are specific to the individual. Therefore, the probability of risk of succumbing for a given individual is expressed as:

pₘ(Dⱼ)=[1+exp(β^{T}Xₘ)]⁻¹ (1).

The individual health risk input module communicates the proposed travel itinerary and all of the health risk prevalence level maps to a projected disease prevalence module 124. The projected disease prevalence module uses the health risk prevalence level map and the proposed travel itinerary to determine for each health risk a projected health risk prevalence level over time at each one of the plurality of locations within the geographical area. In one embodiment, the normalized prevalence level for a given health risk or health condition, j, at a given location, g, within the geographical area at a given time, t, is given by L_{j|g,t}. The health risk prevalence forecast that was generated by the health risk forecasting module is expressed for each health risk as fⱼ(t, g), which is a time-varying and space-varying prevalence level function for health risk j. A constant factor L_{cj} is defined to indicate the standard prevalence level for a given health risk factor j under which the individual health risk model is developed. Therefore, the projected health risk prevalence level can be expressed as:

L_{j|g,t}=fⱼ(t, g)·L_{cj}⁻¹ 2).

The probability of risk of succumbing for a given individual and the projected health risk prevalence level, i.e., equations (1) and (2), are communicated to an individual travel health vulnerability module 128. The individual health vulnerability module uses the individual health risk probability for succumbing and the projected health risk prevalence level for all health risks as well as the proposed travel itinerary, i.e., all locations contained in the portion of the geographical of the proposed travel itinerary and the given time duration of the proposed travel itinerary to generate a personal health risk vulnerability model. The health risk vulnerability model is used to determine an overall health risk vulnerability level value, g, for the given individual m. The overall health risk vulnerability level value is determined by calculating the personal health risk vulnerability model for all health risks, each leg or the proposed travel route or location within the geographical area and the entire time period covered by the travel itinerary.

Returning to FIG. 2, the proposed travel itinerary 252 can be displayed on the health risk prevalence level map 200, for example, by selecting a button 230 provided in the window for the proposed itinerary. Alternatively, a separate map may be displayed just for illustrating the proposed travel itinerary over the desired geographical area. As illustrated, the travel itinerary has two legs connecting three points, a point of origination A 251, an intermediate destination point B 253 and a final destination point 254. The proposed travel itinerary overall vulnerability level value for this exemplary itinerary can be calculated as:

Vₘ=ΣⱼΣ_{k∈A,B,C}∫ₜ_{_{k,str}}^{t}^{_{k,end}}[1+exp(−L_{j|g,t})]⁻¹·pₘ(Dⱼ) (3).

This proposed travel itinerary overall vulnerability level value is displayed within a health risk vulnerability 234 location in the window of the graphical user interface. As is illustrated in FIG. 1, the proposed travel itinerary overall vulnerability level value is communicated to a health risk prevention and control advisor module 132 and a travel itinerary optimizer module 130, which includes a travel route optimizer module and a travel time optimizer module, i.e., modules that can optimize both the spatial and temporal aspects of the travel itinerary. These modules work together to provide a personalized recommendation to the individual for an alternative travel itinerary that varies at least one of the travel route and the timing or duration of travel. These recommendations are made to lower the overall vulnerability level value for that individual associated with the proposed travel itinerary. In one embodiment, the following equation is used to optimize the proposed travel itinerary to reduce individual health risk vulnerability while simultaneously minimizing travel time, cost and a similarity, S(Iₚ,Iₒ), between the original proposed travel itinerary, Iₒ, and a proposed alternative travel itinerary, Iₚ:

max(Trip)=[S(Iₚ,Iₒ)+γ1|Vₘ|+γ2|T|+γ3|C|]⁻¹ (4)

Where T, is the total travel time, C is the total cost and γ1, γ2 and γ3 are user assigned weights to be given to the overall vulnerability level, the travel time and the total cost in constructing an optimized Trip using the alternative travel itinerary that is sufficiently similar to the proposed travel itinerary.

Referring to FIG. 2, the alternative travel itinerary 262 can be displayed on the health risk prevalence level map 200, for example, by selecting a button 232 provided in the window for requesting an improved travel itinerary. Alternatively, a separate map may be displayed just for illustrating proposed and alternative travel itineraries over the desired geographical area. In addition, the alternative travel itinerary can be displayed automatically along with the original proposed travel itinerary. As illustrated, the alternative travel itinerary has two legs connecting three points, the point of origination A 251 from the proposed travel itinerary, an alternative intermediate destination point B′ 263 and an alternative final destination point C′ 264. The alternative travel itinerary overall vulnerability level value for this exemplary itinerary is also displayed 234. The points in the alternative travel itinerary are connected to show the alternative travel route. All of the illustrated travel routes can be displayed in increasing levels of specificity, for example, using the zoom feature of the window. Portions of the alternative travel itinerary can be illustrated in different colors or fonts to highlight the differences or modifications. In addition, selecting a portion of the alternative travel itinerary or moving a cursor over any point along the alternative travel itinerary can pull up more detailed information regarding the alternative travel itinerary. In one embodiment, multiple alternative travel itineraries are generated and displayed. A detailed itinerary in list format can also be displayed.

In addition to alternative travel itineraries being generated automatically or by the individual health vulnerability navigator in response to a request from an individual using the improve button 232 in the map window 204, the map window can display the map of the geographical area in combination with a proposed travel itinerary that can be physically manipulated by the individual within the graphical display. Suitable methods for manipulating travel routes within a graphical display are known an available in the art. The individual health vulnerability navigator in response to the movement, deletion or insertion, for example, of destination points within the graphical environment, computes updated travel routes, travel times, costs and health risk vulnerabilities levels, e.g., the overall vulnerability level for the resulting alternative travel itinerary. One or more of the updated quantities can be displayed within the map window. Therefore, the individual can continue to modify or to manipulate the map until the desired travel itinerary qualities are achieved. In addition to physically moving or adjusting the displayed travel route, the individual can change dates and times associated with the travel itinerary without modifying the travel route or in combination with modifying the travel route.

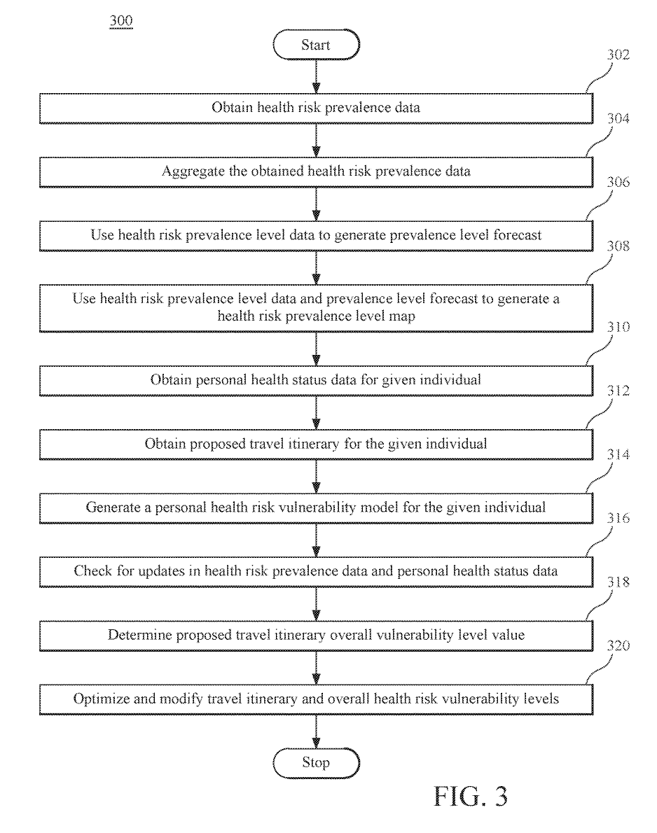

Referring now to FIG. 3, exemplary embodiments are directed to a method for assessing individual health vulnerability 300. Initially, health risk prevalence data are obtained 302. The health risk prevalence level data cover temporally and spatially varying health risk prevalence levels for one or more health risks over a given geographical area. In one embodiment, at least one of aggregate health risk prevalence data covering a plurality of individuals within the given geographical area and individual health risk prevalence data covering individuals at specific locations within the given geographical area are obtained. Suitable health risk prevalence level data include, but are not limited to, a prevalence of infectious disease, a prevalence of climate factors affecting health conditions, a prevalence of geographical features affecting health conditions, a prevalence of sanitation factors affecting health conditions, a prevalence of medical infrastructure and combinations thereof.

In one embodiment, the obtained health risk prevalence data are aggregated 304 to generate the current health risk prevalence levels for each health risk at the plurality of locations within the given geographical area. The health risk prevalence level data are used to generate for each health risk a prevalence level forecast as a function of time and location 306. The health risk prevalence level data and prevalence level forecasts are used to generate a health risk prevalence level map for the given geographical area 308. The health risk prevalence level map illustrates current and future health risk prevalence levels for each health risk at a plurality of locations within the given geographical area. In one embodiment, using the health risk prevalence level data and prevalence level forecasts to generate a health risk prevalence level map further includes using the health risk prevalence level data and prevalence level forecasts to generate a plurality of health risk prevalence level maps for the given geographical area. Each health risk prevalence map illustrates current and future health risk prevalence levels for a single health risk at a plurality of locations within the given geographical area.

Personal health status data are obtained for a given individual 310. An initial or proposed travel itinerary for the given individual 312 is also obtained. The proposed travel itinerary covers at least a portion of the geographical area over a given time duration. Therefore, the travel itinerary includes a travel route, travel times or travel schedule and travel durations, i.e., length of time at a given location within the geographical area. The personal health status data, the proposed travel itinerary and the health risk prevalence level map to generate a personal health risk vulnerability model for the given individual 314. The personal health risk vulnerability model expresses a quantification of vulnerability of the given individual to the one or more health risks resulting from the proposed travel itinerary.

In one embodiment, using the personal health status data, the proposed travel itinerary and the health risk prevalence level map to generate a personal health risk vulnerability model includes determining for the given individual and all health risks an individual health risk probability for succumbing to each health risk. In addition, for each health risk a projected health risk prevalence level over time is determined at each one of the plurality of locations within the geographical area. The individual health risk probability for succumbing and the projected health risk prevalence level for all health risks, all locations contained in the portion of the geographical of the proposed travel itinerary and the given time duration of the proposed travel itinerary are used to generate the personal health risk vulnerability model. In addition to producing the health risk prevalence level map for a given individual, a separate health risk prevalence level map can be produced for each one of a plurality of individuals.

As health risk prevalence levels and personal health status change over time and there is often a time period between the planning of a proposed travel itinerary and the actual travel, a check is made for updates in at least one of the health risk prevalence data and the personal health status data 316. In one embodiment, the personal health status data are updated for the given individual, and the personal health status data, the proposed travel itinerary and the updated health risk prevalence level map to generate an updated personal health risk vulnerability model for the given individual. In addition, each prevalence level forecast, each current health risk prevalence level and each future health risk prevalence level is updated dynamically in real time as additional health risk prevalence level data are obtained.

With current health risk prevalence levels and personal health status data, the vulnerability model is used to determine a proposed travel itinerary overall vulnerability level value 318. The travel itinerary can then be modified or optimized to also modify and optimize, i.e., minimize, the resulting overall health risk vulnerability values are modified and optimized 320. In one embodiment, the given individual is provided with an alternative travel itinerary having a modified overall vulnerability level value that is less than the proposed travel itinerary overall vulnerability level value. This alternative travel itinerary is selected to maximize a similarity between the alternative travel itinerary and the proposed travel itinerary, reduce the overall vulnerability level value, minimize travel time and minimize travel costs.

A graphical user interface can also be used to facilitate modification of the travel itinerary and optimization of the overall health vulnerability level. In one embodiment, the vulnerability model is used to determine a proposed travel itinerary overall vulnerability level value, and the proposed travel itinerary is displayed or illustrated in a graphical user interface, for example, on an interactive map of the geographical area. In one embodiment the proposed travel itinerary is displayed with the proposed travel itinerary overall vulnerability level value. The graphical user interface is used to manipulate, move or shape the proposed travel itinerary into an alternative travel itinerary on the displayed map. A modified overall vulnerability level value is determined that is associated with the alternative travel itinerary. The modified overall vulnerability level value is also displayed in the graphical user interface. All of the necessary portions of the travel itinerary are also updated in accordance with the modified travel route.

Exemplary systems and methods provide information about the best ways to reduce risk of acquiring diseases or experiencing other adverse health effects in a specific location, including avoid ticks, unsafe foods and unsanitary conditions. Information is provided to individual travelers about health resources in the area of the traveler including, for example, the location of medical facilities and pharmacies. This information includes a review of capabilities and expertise, user ratings and location information. Individuals that are participating health professionals are allowed to share their contact information in order to be contacted by and provide medical help to their fellow travelers located nearby. This can even include providing special medical insurance to cover the cost of these consultations.

In one example, a given individual has chronic obstructive pulmonary disease (COPD) and has a proposed travel itinerary covering western China and northern India. A plurality of health risk prevalence level maps are generated including a live disease prevalence map, a weather map (including SMOG pollution in China and information on the direction of prevailing winds), a pollution map showing the location of local pollution sources including, for example, chemical sources and coal factories, a geographical features map showing, for example, altitude information, a food warning map showing local food warning information and a health services map showing the location of third party health services links. In general, these maps show features relevant to the travel itinerary and the individual's personal health status. The individual health risk vulnerability navigator suggests an optimized route and travel itinerary based on the current individual health status.

### Provide Disease Prevention & Risk Control Advice.

For portions of the travel itinerary passing through China, the individual is advised that before flying to Chengdu, a hotel should be booked in the eastern suburbs of the city, as the eastern winds in the area carry the smog away from the eastern neighborhoods. When visiting the Longsheng Rice Terraces, the individual is advised to refrain from eating pickled fish, which are very popular in that area, as pickled fish may harbor intestinal parasites. Additional information provided to the traveler can include tips for avoiding leeches which are abundant in that area and for properly removing leeches if bitten. Should the individual lose an inhaler when travelling in a rural area, directions are provided to the nearest pharmacies and clinics in the area and the name of an equivalent inhaler available in China printed, in both Chinese characters and the individuals native language.

For portions of the travel itinerary passing through India, the individual has proposed a travel itinerary that takes a bus from Ludhiana to Kashmir. An application on the individual's mobile computing device displays the shortest bus route and points out that there is an 8,500 feet high mountain pass. Considering the individual's COPD, the application suggests taking a different bus that will take a little longer but will not expose Bob to low oxygen pressure. When in Kashmir, the application alerts the individual to a dust storm that will take place in a couple of days and provides suggestions on what to do when it comes, e.g., travel 50 miles to the north or visit indoor attractions such as an ancient palace. The individual is advised by the application that multiple travelers in his area reported suffering an attack of gastroenteritis. The application provides tips on how to reduce his risk.

When the individual is on a trek in India and suffers a sprained ankle, limiting the individuals ability to walk, the application searches for medical professionals in the area and activates a request for urgent medical help. A paramedic located an hour away receives the call and comes to examine the individual, diagnosing a sprain and assuring the individual that an x-ray is not needed. The individual is provided with medical treatment that stabilizes the ankle so that the individual can complete the trek. The application, informed of the individual's updated health status, suggests an alternative route to finish the trek that is more accommodating to a sprained ankle. Therefore, the health risk navigator can be used before travel to prepare the best travel itinerary and during travel to modify the itinerary in order to accommodate changing conditions and health status.

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to apparatus (systems) and computer program products according to embodiments of the invention. It will be understood that each description and illustration can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the block diagram block or blocks.

The schematic illustrations and block diagrams in the Figures illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams, and combinations of blocks in the block diagrams, can be implemented by special purpose hardware-based systems that perform the specified functions or acts, or combinations of special purpose hardware and computer instructions.

Methods and systems in accordance with exemplary embodiments of the present invention can take the form of an entirely hardware embodiment, an entirely software embodiment or an embodiment containing both hardware and software elements. In a preferred embodiment, the invention is implemented in software, which includes but is not limited to firmware, resident software and microcode. In addition, exemplary methods and systems can take the form of a computer program product accessible from a computer-usable or computer-readable medium providing program code for use by or in connection with a computer, logical processing unit or any instruction execution system. For the purposes of this description, a computer-usable or computer-readable medium can be any apparatus that can contain, store, communicate, propagate, or transport the program for use by or in connection with the instruction execution system, apparatus, or device. Suitable computer-usable or computer readable mediums include, but are not limited to, electronic, magnetic, optical, electromagnetic, infrared, or semiconductor systems (or apparatuses or devices) or propagation mediums. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Suitable data processing systems for storing and/or executing program code include, but are not limited to, at least one processor coupled directly or indirectly to memory elements through a system bus. The memory elements include local memory employed during actual execution of the program code, bulk storage, and cache memories, which provide temporary storage of at least some program code in order to reduce the number of times code must be retrieved from bulk storage during execution. Input/output or I/O devices, including but not limited to keyboards, displays and pointing devices, can be coupled to the system either directly or through intervening I/O controllers. Exemplary embodiments of the methods and systems in accordance with the present invention also include network adapters coupled to the system to enable the data processing system to become coupled to other data processing systems or remote printers or storage devices through intervening private or public networks. Suitable currently available types of network adapters include, but are not limited to, modems, cable modems, DSL modems, Ethernet cards and combinations thereof.

In one embodiment, the present invention is directed to a machine-readable or computer-readable medium containing a machine-executable or computer-executable code that when read by a machine or computer causes the machine or computer to perform a method for assessing individual health vulnerability in accordance with exemplary embodiments of the present invention and to the computer-executable code itself. The machine-readable or computer-readable code can be any type of code or language capable of being read and executed by the machine or computer and can be expressed in any suitable language or syntax known and available in the art including machine languages, assembler languages, higher level languages, object oriented languages and scripting languages. The computer-executable code can be stored on any suitable storage medium or database, including databases disposed within, in communication with and accessible by computer networks utilized by systems in accordance with the present invention and can be executed on any suitable hardware platform as are known and available in the art including the control systems used to control the presentations of the present invention.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s) and steps or elements from methods in accordance with the present invention can be executed or performed in any suitable order. Therefore, it will be understood that the appended claims are intended to cover all such modifications and embodiments, which would come within the spirit and scope of the present invention.

1-20. (canceled)

21. An individual health vulnerability navigator comprising:
an individual health risk input module to obtain personal health status data for a given individual and a proposed travel itinerary for the given individual, the proposed travel itinerary covering at least a portion of a geographical area over a given time duration;
an individual health risk probability module to use the personal health status data to generate for the given individual and all health risks an individual health risk probability for succumbing to each health risk;
a projected disease prevalence module to use a health risk prevalence level map and the proposed travel itinerary to determine for each health risk a projected health risk prevalence level over time at each one of the plurality of locations within the geographical area; and
an individual travel health vulnerability module to use the individual health risk probability for succumbing and the projected health risk prevalence level for all health risks, all locations contained in the portion of the geographical of the proposed travel itinerary and the given time duration of the proposed travel itinerary to generate the personal health risk vulnerability model.

22. The individual health vulnerability navigator of claim 21, wherein the personal health status data comprise a progression model forecast comprising projected future changes in health status of the given individual.

23. The individual health vulnerability navigator of claim 21, wherein the projected health risk prevalence level comprises a function of a time-varying and space-varying prevalence level function for each health risk and a constant factor comprising a standard prevalence level for each health risk.

24. The individual health vulnerability navigator of claim 21, further comprising at least one computing system then individual health risk input module, the individual health risk probability module, the projected disease prevalence module and the individual travel health vulnerability module executing on the computing system.

25. The individual health vulnerability navigator of claim 21, further comprising a health risk prevalence module to obtain health risk prevalence level data comprising temporally and spatially varying health risk prevalence levels for one or more health risks over the given geographical area.

26. The individual health vulnerability navigator of claim 25, wherein the health risk prevalence level data comprise a prevalence of infectious disease, a prevalence of climate factors affecting health conditions, a prevalence of geographical features affecting health conditions, a prevalence of sanitation factors affecting health conditions, a prevalence of medical infrastructure, prevalence of environmental factors affecting health conditions or combinations thereof.

27. The individual health vulnerability navigator of claim 25, wherein the health risk prevalence module is in communication with at least one aggregate health risk prevalence data source comprising aggregate health risk prevalence data covering a plurality of individuals within the given geographical area and a plurality of distributed individual health risk prevalence data sources comprising individual health risk prevalence data covering individuals at specific locations within the given geographical area.

28. The individual health vulnerability navigator of claim 21, further comprising a health risk forecasting module to use the health risk prevalence level data to generate for each health risk a prevalence level forecast as a function of time and location.

29. The individual health vulnerability navigator of claim 28, wherein the health risk prevalence forecasting module comprises a forecast engine to use all obtained health risk prevalence level data to generate a plurality of prevalence level forecasts, one for each health risk.

30. The individual health vulnerability navigator of claim 21, further comprising a health risk prevalence level data aggregating module in communication with the health risk prevalence forecasting module to aggregate all obtained health risk prevalence level data.

31. The individual health vulnerability navigator of claim 21, further comprising a graphical user interface, a health risk prevalence level map illustrating the proposed travel itinerary displayed in the graphical user interface.

32. The individual health vulnerability navigator of claim 31, wherein the health risk prevalence level map comprises a plurality of health risk prevalence level maps displayed in a layered arrangement in the graphical user interface, each individual prevalence level map associated with one health risk.

33. The individual health vulnerability navigator of claim 31, wherein the health risk prevalence level map comprises an interactive graphical display.

34. The individual health vulnerability navigator of claim 31, wherein the health risk prevalence level map illustrates an alternative travel itinerary separate from the proposed travel itinerary, the proposed travel itinerary comprising a proposed travel itinerary overall vulnerability level value and the alternative travel itinerary comprising an alternative travel itinerary overall vulnerability level value, the alternative travel itinerary overall vulnerability level value less than the proposed travel itinerary overall vulnerability level value.

35. The individual health vulnerability navigator of claim 21, further comprising a health risk prevention and control advisor module and a travel itinerary optimizer module to optimize spatial and temporal aspects of the proposed travel itinerary to minimize a proposed travel itinerary overall vulnerability level value.

36. The individual health vulnerability navigator of claim 35, wherein the travel itinerary optimizer module comprises a travel route optimizer module and a travel time optimizer module.

37. The individual health vulnerability navigator of claim 21, further comprising a health risk prevalence mapping module to use the health risk prevalence level data and prevalence level forecasts to generate a health risk prevalence level map for the given geographical area illustrating current and future health risk prevalence levels for each health risk at a plurality of locations within the given geographical area.
